(19) United States
(12) Patent Application Publication
(10) Pub. No.: US 2017/0122012 A1
(43) Pub. Date: May 4, 2017

(54) LATCH ASSEMBLY FOR VEHICLE

(71) Applicant: Hyundai Motor Company, Seoul (KR)

(72) Inventor: Kyung Hyun Nam, Jeollabuk-do (KR)

(21) Appl. No.: 15/232,470

(22) Filed: Aug. 9, 2016

(30) Foreign Application Priority Data
Nov. 3, 2015 (KR) 10-2015-0153635

(51) Int. Cl. E05B 85/26; E05B 83/18; E05B 79/20; E05B 85/24

(52) U.S. Cl. CPC E05B 85/26; E05B 85/243; E05B 83/18; E05B 79/20

(57) ABSTRACT

A latch assembly which is installed in a tail gate for a vehicle (e.g., a middle-sized or small-sized bus) is provided. The latch assembly for a vehicle with a separated type pawl structure includes a first pawl that is configured to be captured by and released from a claw and a second pawl that is configured to be operated by a cable. In particular, the latch assembly includes a direction of transmission of a load of the claw and a direction of operating force of the pawl that are disposed perpendicular to each other. Accordingly, a loss of operating force in a direction of a load of the claw is minimized and latch operating performance is improved by reducing operating force of the pawl and the claw.

### CROSS-REFERENCE TO RELATED APPLICATION

This application claims under 35 U.S.C. §119(a) the benefit of Korean Patent Application No. 10-2015-0153635 filed on Nov. 3, 2015, the entire contents of which are incorporated herein by reference.

### BACKGROUND

### (a) Technical Field

The present disclosure relates to a latch assembly disposed in a tail gate of a vehicle and more particularly, to a latch assembly for a vehicle, which improves operating force by applying a separated type pawl structure.

### (b) Background Art

Generally, a door for a vehicle is provided with a latch assembly which is connected with a handle to open and close the door. The latch assembly includes a plurality of levers and arms and operates mechanically. Further, a tail gate is installed in a vehicle that requires a larger open area at a rear side of the vehicle and the latch assembly is installed at a lower portion of the tail gate to control the operations of the tail gate. Typically, as the tail gate for a middle-sized or small-sized bus has been developed, a size of the tail gate has significantly increased due to characteristics of the commercial vehicle in comparison with a passenger vehicle.

As the size of the tail gate increases as described above, reaction force of a weather strip is also increased. Accordingly, a load exerted on the latch assembly also increases. As the load exerted on the latch increases a pawl and claw structure of the existing sliding type cannot be pulled intermittently mainly caused by an increase in closing depth of the tail gate compared to specifications.

However, a fundamental solution has not been presented. For example, as illustrated in FIG. 1, a striker 100 is configured to move to the right by reaction force of the weather strip, and the pulling force of the striker 100 increases as the reaction force of the weather strip increases. Subsequently, a protrusion 120a of a claw 110 comes into contact with a protrusion 120b of a pawl 130 while the claw 110 rotates clockwise, and the claw 110 presses the pawl 130 in a left direction. Accordingly, the pawl 130 is configured to receive frictional resistance caused by frictional force with the claw 110 to be rotated.

Since the frictional force is proportional to vertical force, the operating force is required to be greater than frictional force to perform an operation. A rotation direction of the pawl 130 is opposite to a direction of the frictional force. Accordingly, when force for pulling a cable 140 is less than the frictional force, an operation cannot be performed. An operation by the latch maybe difficult since the claw cannot be rotated during an operation of the pawl. For example, a substantial operating force is required to be exerted until the pawl is completely released.

The above information disclosed in this section is merely for enhancement of understanding of the background of the invention and therefore it may contain information that does not form the prior art that is already known in this country to a person of ordinary skill in the art.

### SUMMARY

The present invention provides a latch assembly for a vehicle that includes a separated type pawl structure. The separated type pawl structure may include a first pawl configured to be captured by and released from a claw and a second pawl configured to be operated by a cable. The latch assembly may include a direction of transmission of a load of the claw and a direction of operating force of the pawl that are disposed perpendicular to each other. Accordingly, a loss of operating force may be minimized in a direction of a load of the claw and may improve the latch operating performance by reducing operating force of the pawl and the claw.

In one aspect, the present invention provides a latch assembly for a vehicle that may include a claw configured to be captured by and released from a striker and a pawl configured to be captured by and released from the claw operated by a cable. The pawl may include a second pawl coupled to the cable and rotatably supported by a second pin and a second spring. A first pawl may be rotatably supported on the second pawl by a first pin and a first spring and configured to be captured by and released from the claw through a front end portion of the first pawl.

In an exemplary embodiment, the claw and the second pawl may be disposed vertically, the first pawl may be disposed between the claw and the second pawl, and the first pawl may be configured to be captured by and released from the claw through contact with the claw. In another exemplary embodiment, when a protrusion portion disposed on the claw abuts a front end nose disposed on the first pawl, the claw may be configured to exert a rotational force in a direction perpendicular to a contact surface between the protrusion portion and the nose.

In still another exemplary embodiment, a substantially straight line that extends in a vertical direction may be a direction of rotational force of the claw and may extend through a center of the second pin of the second pawl. A substantially straight line that extends in a vertical direction may be a direction of rotational force of the claw and may be positioned below a center of the first pin of the first pawl. In another exemplary embodiment, the first spring that elastically supports the first pawl may be mounted to couple the second pawl through a first end of the first spring, may be wound around the first pin, and may be coupled to the first pawl through a second end of the first spring, and a slot may be formed at a portion of the first pawl coupled to the spring.

The latch assembly provided in the present invention may include a structure that separates the pawl and minimizes an influence on frictional force when a primary load causes a reduction of operating force of the existing claw and pawl, thereby having the following advantages.

First, a significant reduction of the latch releasing and operating force may occur by applying a separated type pawl structure.

Secondly, the operating force may be reduced by 50% or more when an actual product is manufactured even though a level capable of reducing operating force is theoretically about 90%.

Third, the latch assembly may be widely applied to a large-sized product such as a tail gate or a sliding door because operating force may be reduced.

Fourth, the operating force may be manage for doors of commercial vehicles having a larger structure compared to a passenger vehicle and the operating force may be equal to or less than the operating force of the passenger vehicle.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is an exemplary front view illustrating a latch assembly in the related art;

FIG. 2 is an exemplary perspective view illustrating a latch assembly according to an exemplary embodiment of the present invention;

FIGS. 3A and 3B are an exemplary front view and an exemplary perspective view illustrating an operational relationship between a pawl and a claw of the latch assembly according to the exemplary embodiment of the present invention;

FIGS. 4A-4F are an exemplary front views illustrating a released state of the latch assembly according to the exemplary embodiment of the present invention; and

FIGS. 5A-5E are an exemplary front views illustrating a locked state of the latch assembly according to the exemplary embodiment of the present invention.

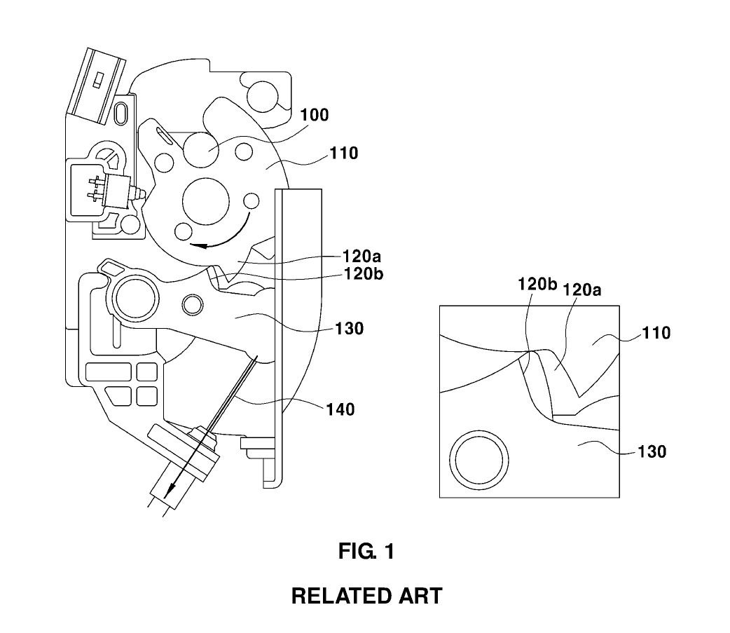

Reference numerals set forth in the Drawings includes reference to the following elements as further discussed below:

10: striker

11: claw

12: cable

13: pawl

13a: first pawl

13b: second pawl

14: second pin

15: second spring

16: first pin

17: first spring

18: protrusion portion

19: nose

20: contact surface

21: latch base

22: cover

23: first cover bracket

24: second cover bracket

25: switch/connector assembly

26: claw pin

27: claw spring

28: striker catching groove

29: cable aperture

30: first pawl stand

31: slot

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

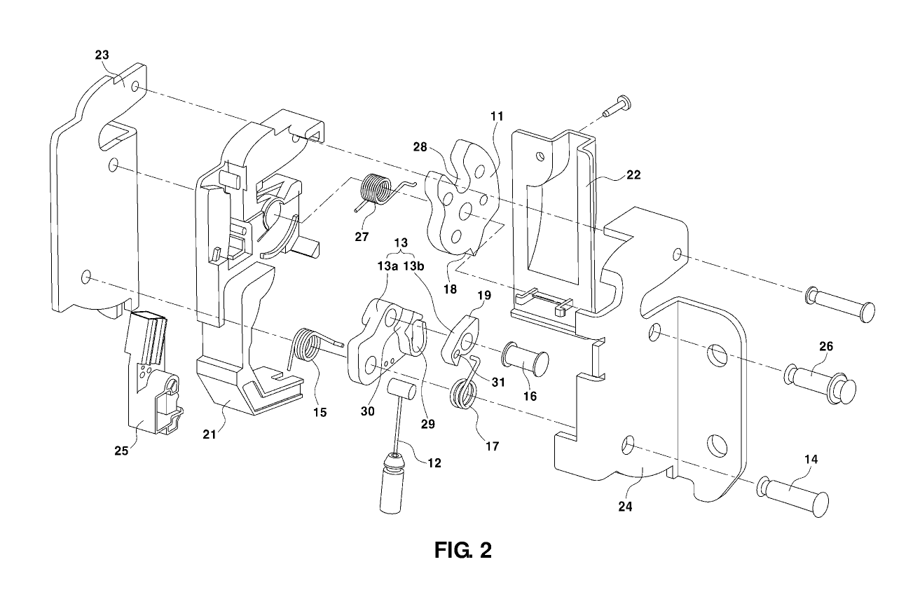

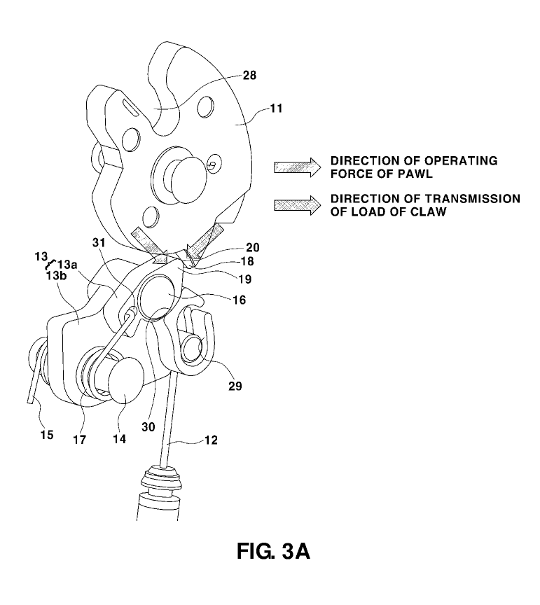

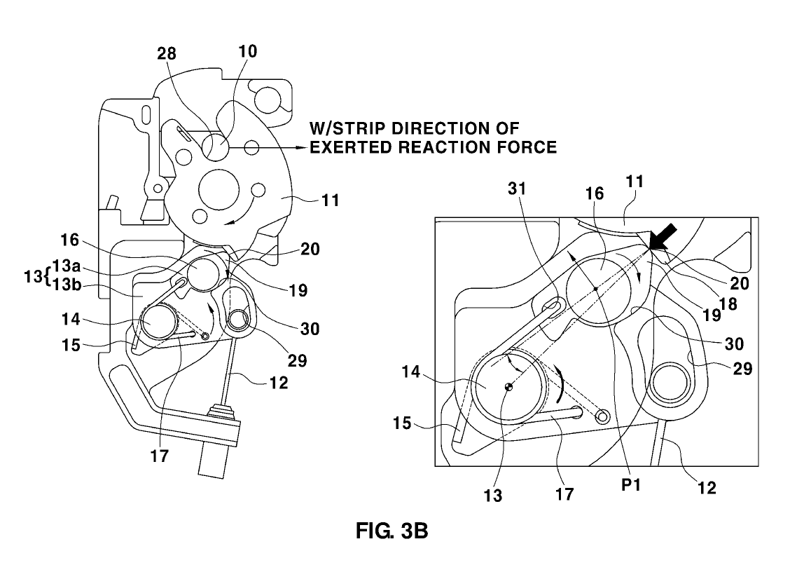

Hereinafter, the present invention will be described in detail with reference to the accompanying drawings. FIG. 2 is an exemplary perspective view illustrating a latch assembly according to an exemplary embodiment of the present invention. FIGS. 3A and 3B are an exemplary front view and an exemplary perspective view illustrating an operational relationship between a pawl and a claw of the latch assembly according to the exemplary embodiment of the present invention.

As illustrated in FIGS. 2, 3A and 3B, the latch assembly may include a separated type pawl structure that may reduce the operating force of a pawl and a claw. In particular, the latch assembly may include a latch base 21 on which a claw 11 and the like may be disposed and a cover 22, a first cover bracket 23, and a second cover bracket 24, that may be coupled to a front side and a first and second lateral sides of the latch base 21 and may protect the claw 11 and a pawl 13. A typical switch/connector assembly 25 configured to detect an operational state of the pawl 13 and the claw 11 may be disposed at a rear side of the latch base 21. The latch assembly includes the claw 11 and may be configured to be captured by and released from a striker 10.

The claw 11 may be a plate member configured to capture and release the striker 10. A claw pin 26 may penetrate a center of the claw 11 and the claw 11 may be mounted on the latch base 21 and may be configured to be rotatable about the pin. A claw spring 27 may include a first end fixed to the latch base 21 and a second end fixed to the claw 11 mounted at a portion where the claw pin 26 is coupled and the claw 11 may be configured to rotate in one direction (e.g., clockwise) by being elastically supported by the claw spring 27. In other words, since a striker catching groove 28 of the claw 11 may be configured to receive force of the claw spring 27 when the striker catching groove 28 is released from the pawl, the striker catching groove may be directed toward a front side where the striker 10 enters. The striker catching groove 28, that captures the striker 10may be formed at an upper end of the claw 11. A protrusion portion 18 may be captured by or released from the latch may be formed at an outer circumferential portion at a lower end of the claw 11. In other words, the protrusion portion 18 may include a flat portion approximately perpendicular to a tangential direction of a claw body. Therefore, the claw 11 may be elastically supported by the claw spring 27 and may be configured to be captured by and released from the striker 10 through the striker catching groove 28 while being rotated about the claw spring 27 and may be captured by and released from the pawl 13 by the protrusion portion 18.

The latch assembly may include the pawl 13 that may be configured to capture or release the claw 11 by being operated (e.g., pulled) by a cable 12 or returned by spring force. The pawl 13 may include a combination of a first pawl 13a and a second pawl 13b which are disposed at a lower side of the claw 11 and may be configured to be captured by and released from the claw. In other words, the pawl 13 may have a combination structure that includes the second pawl 13b connected to the cable 12 and rotatably supported by a second pin 14 and a second spring 15 and the first pawl 13a rotatably supported on the second pawl 13b by a first pin 16 and a first spring 17 and may be configured to be captured by and released from the claw 11 through a front end portion of the first pawl 13a.

The second pawl 13b may be mounted on the first cover bracket 23 and the second cover bracket 24 to be rotatable about the pin when the second pin 14 penetrates a rear end portion of the second pawl 13b. The second spring 15 may include a first end fixed to the latch base 21 and a second end fixed to the second pawl 13b and may be mounted at a portion where the second pin 14 is coupled. Accordingly, the second pawl 13b may be configured to rotate in one direction by being elastically supported by the second spring 15. In other words, the second pawl 13b may be configured to rotate counterclockwise by receiving force of the second spring 15 when the pulling force generated by the cable 12 is released and as the rear end portion thereof contacts an interior wall surface of the latch base 21, the rotation of the second pawl 13b may be restricted to maintain a nearly horizontal posture of the second pawl 13b.

A cable aperture 29, may be formed in the form of a long aperture, and may be formed in the front end portion of the second pawl 13b. An end body of the cable 12 may be connected to the cable aperture 29 by being fitted into and caught by the cable aperture 29. Therefore, when the cable 12 is pulled, the second pawl 13b may be configured to rotate clockwise about the second pin 14 while the front end portion of the second pawl 13b is pulled. Further, when the pulling force of the cable 12 is dissipated, the second pawl 13b may be configured to return to an initial position while being rotated counterclockwise by force of the second spring 15. The first pawl 13a may be mounted at a front side at an upper end of the second pawl 13b and may be configured to be rotated about the pin when the first pin 16 penetrates a center of the first pawl 13a.

The first spring 17, may include a first end fixed to the second pawl 13b and a second end fixed to the first pawl 13a and may be mounted at a portion where the first pin 14 is coupled. In other words, the first spring 17 may be mounted to be fixed to the second pawl 13b through a first end of the first spring 17, wound around the first pin 16 one or more times, and then fixed to the rear end portion of the first pawl 13a through the second end of the first spring 17. In particular, the first spring 17 may elastically support the first pawl 13a in one direction. Therefore, the first pawl 13a may be configured to rotate in one direction by being elastically supported by the first spring 17.

Furthermore, the first pawl 13a may be configured to be rotated clockwise by receiving force of the first spring 17 when the first pawl 13a is not tilted counterclockwise by the protrusion portion 18 of the claw 11. The rotation of the first pawl 13a may be restricted as the lower end portion of the first pawl 13a is seated on a first pawl support projection 30 that protrudes at a front side of the second pawl 13b, to maintain an inclined posture of the first pawl 13a to position a nose 19 of the first pawl 13a adjacent to the flat portion of the protrusion portion 18 disposed on the claw 11. The front end portion of the first pawl 13a may be formed as the nose 19. Namely, the nose 19 may engage the protrusion portion 18 of the claw 11, and may be configured to thereby capture the claw 11.

A slot 31 may be formed at a portion of the first pawl 13a where the spring is fixed. In other words, a portion where a first end of the first spring 17 is fixed, thereby excluding interference at the spring side along a rotation trajectory of the first pawl 13a. Therefore, when the first pawl 13a is tilted by the claw 11 that may be configured to rotate clockwise, the first pawl 13a may be configured to rotate counterclockwise while compressing the first spring 17. Further, when the interference with the claw 11 is released, the first pawl 13a may be configured to return to the initial position in the inclined posture while being rotated clockwise by receiving restoring force of the first spring 17. For example, the first pawl 13a may be disposed between the claw 11 and the second pawl 13b which are vertically disposed. The first pawl 13a may be configured to be captured and released by the protrusion portion 18 of the claw 11 through the nose 19 at the front end portion of the first pawl 13a.

In particular, the present invention provides a structure that may minimize a loss of operating force in a direction of a load of the claw (e.g., force by which the claw presses the pawl while being rotated clockwise). In other words, when the protrusion portion 18 disposed on the claw 11 contacts the front end nose 19 disposed on the first pawl 13a, rotational force of the claw may be configured to be exerted perpendicular to a contact surface 20 between the protrusion portion 18 and the nose 19. In particular, the contact surface 20 may be disposed on a straight line approximately parallel to the flat portion of the protrusion portion that extends through an interface between the nose portion and the flat portion of the protrusion portion.

A sustainably straight line, which extends in the vertical direction that is the direction of the rotational force of the claw 11, may extend through a center P2 of the second pin 14 of the second pawl 13b. Namely, the center P2 of the second pin 14 and the contact surface 20 may be placed in a single substantially straight line. The substantially straight line, may extend in the vertical direction that is the direction of the rotational force of the claw 11 and may be positioned below a center P1 of the first pin 16 of the first pawl 13a. Accordingly, the claw 11 may be configured to exert force to rotate the first pawl 13a clockwise.

Consequently, the force may be converted into force configured to displace the first pawl 13a in an upper end direction and a direction of moment of force exerted on the first pawl 13a may be in a counterclockwise direction. For example, a direction of all force may be coincident with an initially set direction and a closed state of the latch according to the present invention may be maintained upon exertion of an external force. Therefore, an operational state of the latch assembly configured as described above will be described below.

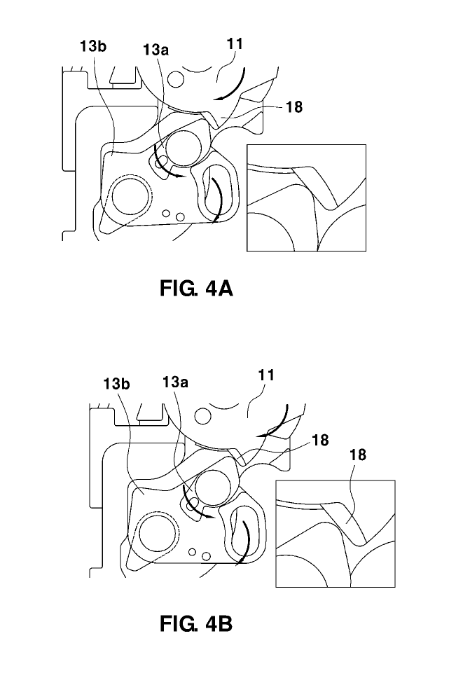

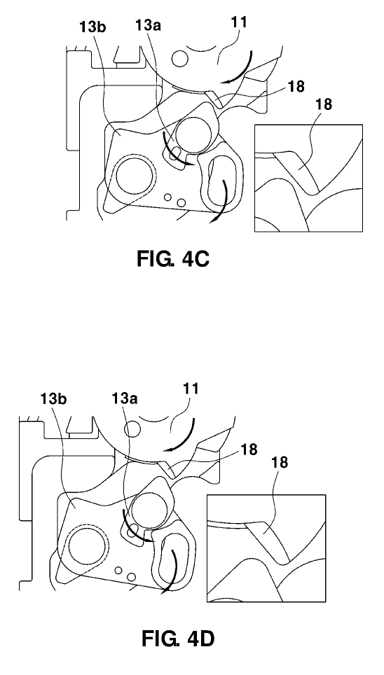

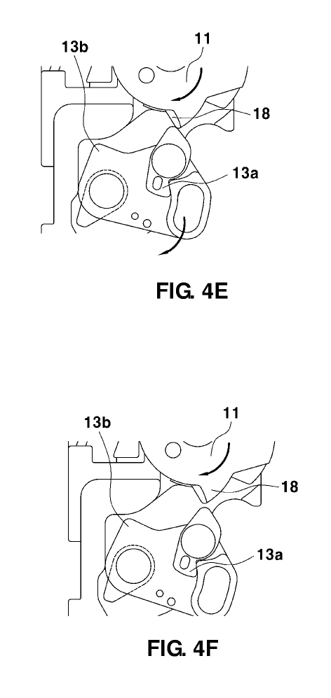

FIGS. 4A-4F is a front view illustrating a released state of the latch assembly according to the exemplary embodiment of the present invention. As shown in FIG. 4A the cable 12 may be configured to actuate (e.g., pull) the second pawl 13b. As shown in FIG. 4B the second pawl 13b may be configured to rotate clockwise (e.g., no frictional force at a rotating portion). As shown in FIG. 4C the first pawl 13a may be configured to rotate counterclockwise by friction of the claw 11. In other words, the claw 11 may be configured to rotate clockwise and may correspond to the rotation of the first pawl 13a. A vertical force between the claw and the pawl may be reduced when reaction force caused by a weather strip is reduced by the rotation of the claw 11 (e.g., as the pressed weather strip is gradually restored). Accordingly, the operating force may be improved since frictional force may be reduced.

Furthermore, when the claw 11 is configured to gradually rotate clockwise the degree to which the weather strip is pressed may be gradually reduced. When the degree that the weather strip is pressed is reduced gradually as described above, reaction force of the weather strip may be gradually reduced and a vertical force may be gradually reduced, to reduce the frictional force. As shown in FIG. 4D the first pawl 13a may be stopped by a capture projection (e.g., a lateral portion of the first pawl support projection) of the second pawl 13b. Thereafter, as shown in FIG. 4E, a state in which the second pawl 13b is pulled alone may be maintained. As shown in FIG. 4F the protrusion portion of the claw 11 may be configured to be released from the nose of the first pawl 13a and the claw 11 may be configured to rotate clockwise and then may attain a latch released position.

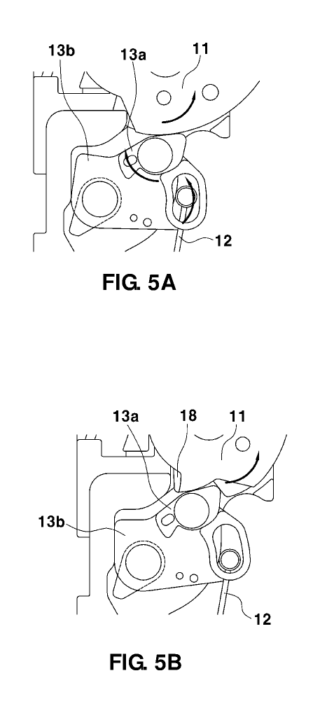

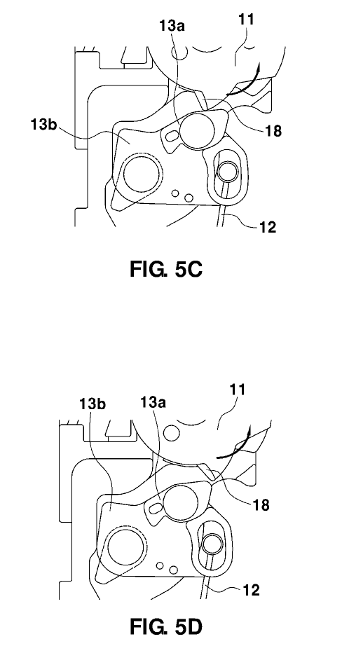

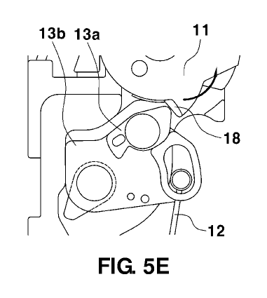

FIGS. 5A-5E are exemplary front view illustrating a locked state of the latch assembly according to the exemplary embodiment of the present invention. As shown in FIG. 5A the present state may be identical to a fully locked state of the latch assembly. As shown in FIG. 5B the claw 11 may be configured to rotate counterclockwise when the latch is closed. As shown in FIG. 5C the first pawl 13a may be configured to rotate in a clockwise direction by the first spring and the first pawl 13a may be supported by the first pawl support projection and does not rotate. As shown in FIG. 5D the second pawl 13b may be configured to rotate in a counterclockwise direction by the second spring and may be disposed in a horizontal position when the rear end portion of the second pawl 13b is caught by the interior wall surface of the latch base. Accordingly, a first stage lock occurs. When as shown in FIG. 5E, the claw 11 rotates counterclockwise, the protrusion portion of the claw 11 may be configured to pass over the nose portion of the first pawl 13a and the first pawl 13a may be configured to rotate counterclockwise to be captured by the protrusion portion of the claw 11 while standing disposed at an inclined angle. In other words the second pawl 13b may be disposed in a horizontal position as the rear end portion of the second pawl 13b may be captured by the interior wall surface of the latch base and when a fully locked state is made a second stage lock may also be made.

As described above, the present invention separates the existing pawl structure and minimizes an influence on frictional force which is a primary load that causes a loss of operating force of the existing pawl and claw. Accordingly, the operating force for releasing the latch may be significantly reduced.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A latch assembly for a vehicle, comprising:
a claw configured to be caught by and released from a striker; and
a pawl operated by a cable configured to be captured by and released from the claw,
wherein the pawl includes a first pawl and a second pawl, and
wherein the first pawl is rotatably supported on the second pawl by a first pin and a first spring and is configured to be captured by and released from the claw through a front end portion of the first pawl, and the second pawl is coupled to the cable and rotatably supported by a second pin and a second spring.

2. The latch assembly of claim 1, wherein the claw and the second pawl are disposed vertically, the first pawl is disposed between the claw and the second pawl, and the first pawl is configured to be captured by and released from the claw through contact with the claw.

3. The latch assembly of claim 1, wherein a protrusion portion disposed on the claw abuts a front end nose disposed on the first pawl, the claw is configured to exert rotational force in a direction perpendicular to a contact surface between the protrusion portion and the nose.

4. The latch assembly of claim 3, wherein a substantially straight line, that extends in a vertical direction that is a direction of rotational force of the claw, extends through a center of the second pin of the second pawl.

5. The latch assembly of claim 3, wherein a straight line, extends in a vertical direction that is a direction of rotational force of the claw, is positioned below a center of the first pin of the first pawl.

6. The latch assembly of claim 1, wherein the first spring, that elastically supports the first pawl, is coupled to the second pawl through a first end of the first spring, wound around the first pin, and coupled to the first pawl through a second end of the first spring.

7. The latch assembly of claim 6, wherein a slot is formed at a portion of the first pawl that is coupled to the spring.
